(19) United States
(12) Patent Application Publication
(10) Pub. No.: US 2008/0052691 A1
(43) Pub. Date: Feb. 28, 2008

(54) Communicating with and recovering state information from a dynamic translator

(76) Inventors: Naveen Neelakantam, Naperville, IL (US); Gregory M. Lueck, N. Chelmsford, MA (US); Christopher L. Elford, Hillsboro, OR (US); Suresh Srinivas, Portland, OR (US); Robert S. Cohn, Salem, NH (US)

Correspondence Address: TROP PRUNER & HU, PC, 1616 S. VOSS ROAD, SUITE 750, HOUSTON, TX, 77057-2631, US

(21) Appl. No.: 11/478,965

(22) Filed: Jun. 29, 2006

(51) Int. Cl. G06F 9/45

(52) U.S. Cl. 717/148; 717/136

(57) ABSTRACT

A technique includes communicating a message to a dynamic translator in response to a change, which affects the validity of a translation that is performed by the dynamic translator.

### BACKGROUND

The invention generally relates to communicating with and recovering state information from a dynamic translator.

There are three conventional approaches to building analysis tools for managed applications: manually instrumenting the run time, instrumenting the managed application by building plugins to virtual machine tool interfaces and using hardware performance monitoring.

Managed run time analysis tools may be used by a variety of different users. Managed application developers use the analysis tools to gain insight into the behavior of their application and the way the application interacts with the underlying run time and the platform. Managed run time developers use the analysis tools to determine how the managed work load performance is influenced by the implementation of the managed run time. Computer architects use the analysis tools to gain insight into the behavior of managed run time workloads and how the managed run time work loads are different from unmanaged applications to help the computer architects design new features that overcome the various challenges that are posed by managed run time environments.

Given the different needs of the users of managed run time analysis tools, a flexible framework for building tools, i.e., a “toolkit,” may be more desirable than a set of specialized tools. Especially true for analysis tools that are built using manual instrumentation, constructing a tool may be a painstaking process due to the difficulty involved with finding the correct instrumentation points, as well as making safe modifications to the application or run time. A toolkit facilitates building analysis tools by providing abstractions that simplify selection of instrumentation points and permit the safe insertion of analysis code.

### BRIEF DESCRIPTION OF THE DRAWING

FIG. 1 is a schematic diagram of a managed run time environment according to an embodiment of the invention.

FIG. 2 is a flow diagram depicting communication with a dynamic translator according to an embodiment of the invention.

FIG. 3 is a schematic diagram depicting the flow of program code in the managed run time environment of FIG. 1 according to an embodiment of the invention.

FIG. 4 is an illustration of native code generated by the virtual machine of FIG. 1 according to an embodiment of the invention.

FIG. 5 is a flow diagram depicting a technique to recover pristine state information according to an embodiment of the invention.

FIG. 6 is a schematic diagram of a computer system according to an embodiment of the invention.

### DETAILED DESCRIPTION

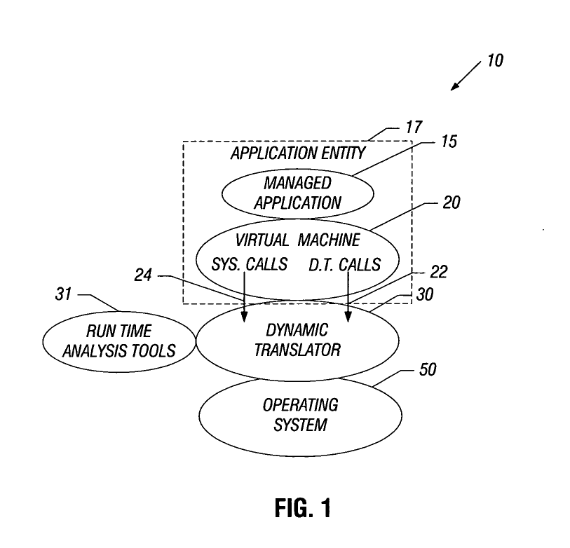

Referring to FIG. 1, in accordance with some embodiments of the invention, an execution environment 10 is formed at least in part by an application entity 17, a dynamic binary translator (herein called the “dynamic translator 30”) and an operating system 50. In accordance with some embodiments of the invention, the application entity 17 may be a stand alone application software package, such as a photograph editing application (as an example), which is written for a particular operating system. In other embodiments of the invention, as described below, the application entity 17 may include an application manager, such as a virtual machine 20 (a JAVA® virtual machine, for example), and a managed application 15. The virtual machine 20 converts platform independent instructions (such as “bytecode,” for example) of the managed application 15 into native code to be executed by a microprocessor.

Regardless of the particular form or makeup of the application entity 17, the execution environment 10 provides a framework that facilitates the use of analysis tools to observe the behavior of the application entity 17 and how the application entity 17 interacts with the execution environment 10. The dynamic translator 30 resides (in terms of software hierarchy) between the application entity 17 and the operating system 50 and is generally transparent to the application entity 17. The dynamic translator 30 provides an instrumentation platform for a variety of run time analysis tools 31, which may be used for purposes of analyzing or debugging the application entity 17, observing the behavior of the execution environment 10, monitoring the workload of the execution environment 10, evaluating the design of the underlying hardware architecture, etc.

In accordance with some embodiments of the invention, the dynamic translator 30 instruments the application entity 17 in a transparent manner, meaning that the instructions and data that are accessed by the application entity 17 appear to be the same as if the application entity 17 were uninstrumented. As a more specific example, in accordance with some embodiments of the invention, the dynamic translator 30 may be part of a Program Instrumentation (PIN) tool software package, version 2.0 (2006), which is available either from Intel® Corporation or the University of Colorado and may be installed on a computer system (a desktop or portable computer, as examples) as a plug-in.

A difficulty in using the dynamic translator 30 is that the application entity 17 may use self-modifying code (herein called “SMC”), which if not for the features described herein, may cause the dynamic translator 30 to provide invalid, or “stale,” translations of the native code. SMC is described below for the case in which the virtual machine 20 modifies the pristine, or native, code that is generated by virtual machine 20. However, it is understood that in other embodiments of the invention, SMC may occur in different ways, such as the case in which an application entity inserts an immediate operand to rewrite its own code.

For embodiments in which the application entity 17 is formed from the managed application 15 and virtual machine 20, SMC may occur in connection with at least three different scenarios. The first scenario involves the virtual machine's management of its generated native code. More specifically, the dynamic translator 30 generates translations of the native code, which is provided by the virtual machine 20, upon the first execution of the native code. The virtual machine 20 manages its generated native code in a code cache, which is a finitely sized area of memory that contains natively compiled methods. If the code footprint of the managed application 15 exceeds the size of the code cache (not shown), the virtual machine 20 evicts code from the code cache to reclaim space for more recently executed methods. Whenever the virtual machine 20 writes natively compiled methods into reclaimed space, the virtual machine 20 effectively modifies the generated code by overwriting evicted code. If the evicted code had previously been executed, then the dynamic translator 30 has generated translations for the previously executed code. Therefore, when the virtual machine 20 overwrites the evicted code, the corresponding translations are no longer valid.

A second scenario in which SMC occurs pertains to staged optimizations, which the virtual machine 20 may use to focus compilation efforts onto more frequently executed code. For example, the first time the virtual machine 20 executes a particular method, the virtual machine 20 may compile the method into corresponding native code. If a method gets executed more frequently, the virtual machine 20 applies more aggressive optimizations. As a result, natively compiled methods are replaced in the code cache in that the virtual machine 20 overwrites native instructions either with optimized instructions or with instructions that “trap,” so that callers of the native method compilation are “backpatched”, or redirected to the optimized instructions. Because the native instructions have already been executed, the corresponding translations that are used by the dynamic translator 30 are no longer valid.

A third scenario in which SMC appears is in connection with code patching, which, in general, may be used by the virtual machine 20 to modify specific pieces of methods. For example, the above-described backpatching is an example of code patching, which may be used by the virtual machine 20, in general, to redirect callers of methods that have been patched. Therefore, code patching also invalidates translations that are used by the dynamic translator 30.

Each of the three above-described uses of SMC poses the same challenge to the dynamic translator 30, in that the dynamic translator 30 translates instructions, or code, which are provided by the application entity 17 upon first execution and caches translations for all future uses. If the application entity 17 modifies previously-executed code, then this modification affects the previously created and cached translations for the instructions that are modified. If the dynamic translator 30 does not invalidate the corresponding translations, then the dynamic translator 30 may provide stale translations of the modified instructions. Thus, execution of the incorrect instructions may cause a system slowdown and may cause incorrect analysis results. Furthermore, the execution of stale code may lead to a core dump.

In accordance with embodiments of the invention described herein, an application programming interface (API) is effectively built into the dynamic translator 30 to allow a direct message, or communication, to occur between the dynamic translator 30 and the application entity 17, such as a message that informs the dynamic translator that certain code of the application entity 17 (for which the dynamic translator 30 has already generated natively-compiled code) has been modified by the application entity 17. As further described below, in accordance with some embodiments of the invention, due to the dynamic translator 30 being transparent to the application entity 17, the application entity 17 may be unaware that the communication regarding the modified code is being sent to the dynamic translator 30.

Turning now to the more specific details, in accordance with some embodiments of the invention, the dynamic translator 30 emulates an instruction set architecture (called “ISA”), which is the architecture that is expected by the virtual machine 20; and thus, the native, or pristine, code that is generated by the virtual machine 20 is ISA code, in accordance with some embodiments of the invention. In accordance with some embodiments of the invention, the dynamic translator 30 runs in user mode (as compared to privileged, system mode) and emulates operating system 50 application programming interfaces (APIs) for the virtual machine 20. In particular, the dynamic translator 30 intercepts system calls (a file open call, as an example) that the application entity 17 makes to the operating system kernel and emulates the expected response by the operating system 50.

The above-described interception of application system calls is also used, in accordance with some embodiments of the invention, for purposes of facilitating the above-mentioned direct communication between the application entity 17 and the dynamic translator 30. More particularly, in accordance with some embodiments of the invention, previously unused system call vectors, which are meaningful only to the dynamic translator 30, are dedicated for this communication. As with other system calls, when the application code is translated these additional system calls are handled by the dynamic translator 30, and when one of these system calls is invoked, the dynamic translator 30 recognizes that the system call vector is part of an API of the dynamic translator 30, not an operating system API; and thus, in accordance with embodiments of the invention, the dynamic translator 30 performs some action based on the specific call.

Therefore, in accordance with embodiments of the invention, the dynamic translator 30 receives system calls 24 and translator calls 22 from the application entity 17. From the application entity's perspective, both the system 24 and translator 22 calls appear to be operating system calls. However, unlike conventional execution environments, the translator calls 22 are actually calls that allow direct communication between the application entity 17 and the dynamic translator 30 regarding conditions that may affect the validity of translated code that has been generated by the dynamic translator 30.

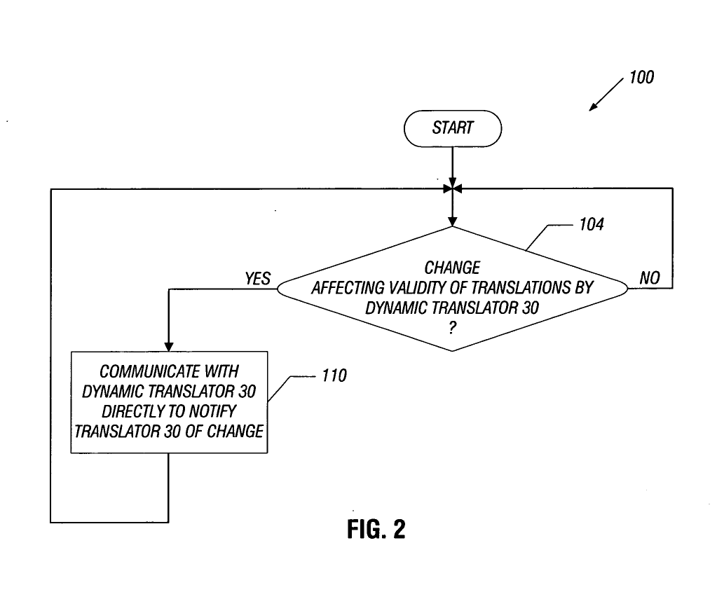

Referring to FIG. 2 in conjunction with FIG. 1, to summarize, a technique 100 may generally be performed by the virtual machine 20 in accordance with some embodiments of the invention. Pursuant to the technique 100, the virtual machine 20 determines (diamond 104) whether a change has occurred, which affects the validity of translations that are generated by the dynamic translator 30. If such a change has occurred, then the virtual machine 20 communicates (block 10) with the dynamic translator 30 to notify the translator 30 of the change and control returns to diamond 104. This communication may involve the virtual machine 20 inserting a specific system call into the native code that is generated by the virtual machine 20.

As a more specific example, in accordance with some embodiments of the invention, the operating system 50 (see FIG. 1) may be a Linux-based operating system. A software interrupt called the “0x80 interrupt” traditionally is used to cause a privileged level operation system call to a Linux-based operating system. Instead of using 0x80 interrupt in this manner, the dynamic translator 30 (see FIG. 1), in accordance with some embodiments of the invention, translates code containing an 0x80 interrupt into a dynamic translator call 22 (see FIG. 1).

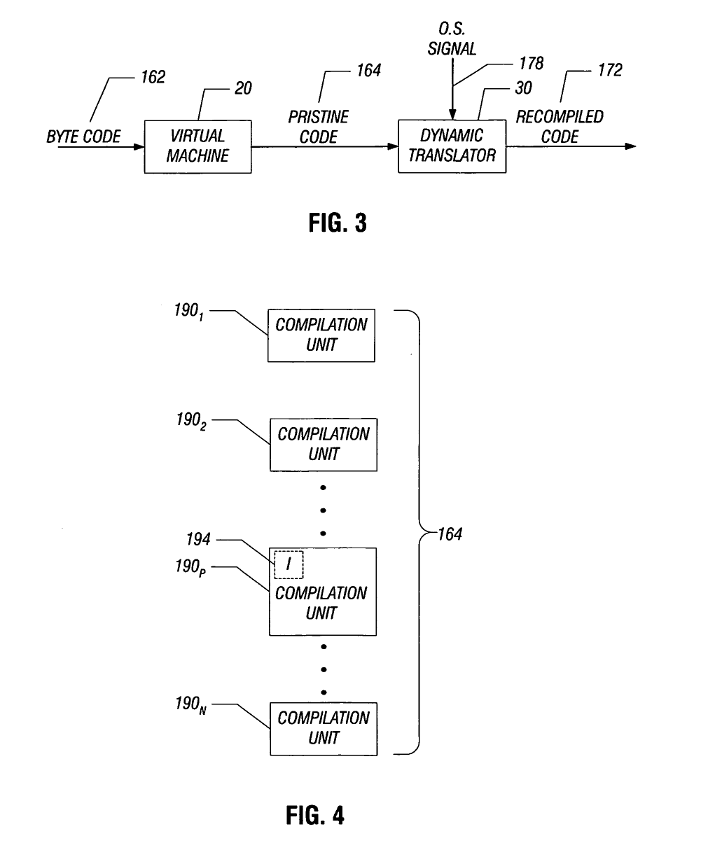

Referring to FIG. 3 in conjunction with FIG. 1, the dynamic translator 30 relies on the recompilation of application binaries to emulate the behavior of the pristine, or uninstrumented, application entity 17. For example, in accordance with some embodiments of the invention, the virtual machine 20 compiles byte code 162 of the managed application 15 to generate native code, which may also be labeled “pristine code 164,” as the code 164 is the pristine ISA code that is in form to be executed by a particular microprocessor. The dynamic translator 30 recompiles the pristine code 164 to generate recompiled code 172, which is the instrumented code that implements the use of the run time analysis tools 31.

Referring to FIG. 4 in conjunction with FIG. 1, the pristine code 164 may be viewed as a set of compilation units, such as exemplary compilation units 190₁, 190₂ . . . , 190_{P} . . . , 190_{N}, which are depicted in FIG. 4. Referring to FIG. 4 in conjunction with FIG. 3, the recompilation of the pristine code 164 by the dynamic translator 30 (to produce the recompiled code 172) may include the insertion or removal of instructions, reallocation of registers and the otherwise modification of the pristine code 164. Even if the dynamic translator 30 maintains program correctness as its makes the modifications, the modifications may pose problems for debugging and application entities that make advanced use of the ISA, as both entities may require that a given visible state that is associated with the recompiled code 172 is identical to the visible state of the pristine code 164. Consequently, it may be important that the dynamic translator 30 is able to recover the precise state associated with the pristine code 164 at each instruction in the recompiled code 172.

For example, in response to the execution of the recompiled code 172 the operating system 50 may generate a particular signal 178 in response to the occurrence of an operating system fault. The signal 178 identifies the system state (register contents, location of instruction that caused fault, etc.) at the time of the fault. However, this state is the state for the translated, or recompiled code 172. To deliver the pristine state (i.e., the state that is associated with the pristine code 164) at the time of the fault, the dynamic binary translator 30, in general, performs a reverse mapping, as described below.

When the operating signal 178 occurs, the precise pristine execution state may not correspond to a location within the recompiled code 172. The virtual machine 20 may not be able to recognize translated code locations and therefore, may be unable to determine if a thread is at a safe point. In addition, to reduce the overhead that is incurred by the dynamic translator 30 and the run time analysis tools 31, registers may be relocated within the translated code. Thus, the pristine execution state that is delivered by the operating system 50 may have register values that do not correspond to an uninstrumented execution of the application entity 17. Additionally, if the virtual machine 20 rolls the execution of a suspended thread forward, the virtual machine 20 modifies the saved process state for the suspended thread. When the thread resumes, the virtual machine 20 uses the modified process state to overwrite the state data structure that is provided by the operating system 50 and then returns from its signal handler (which is entered upon receipt of the resumed signal from the main virtual machine 20 thread). However, the process state that is provided by the virtual machine 20 corresponds to an uninstrumented execution. If execution resumes with this process state, execution does not resume within the translated code, and the dynamic translator 30 has lost control of the virtual machine 20.

In accordance with embodiments described herein, precise recovery of the pristine state (the instruction address, register state, etc., as examples) of code that has been dynamically translated is recovered without explicit storage of complete mapping information. If the dynamic translator 30 maintains precise mappings from the translated to the pristine state for every instruction address in the original code, a vast amount of data may be maintained and/or stored. However, application entities that make use of the ISA may require this level of precision. When executing these advanced application entities, a dynamic translator may fail if unable to provide the pristine state. In accordance with embodiments of the invention described herein, the storage that is used to provide the pristine state information is limited in that only the mapping to the pristine state at the beginning of each compilation unit (see FIG. 4) is stored. From this reduced set of mapping information, the pristine state for arbitrary locations in the compilation unit may be recovered without incurring the overhead that is associated in maintaining all of the mapping information.

More specifically, recovering the pristine state involves a reverse mapping from the state associated with an instruction in the recompiled code 72 to the corresponding pristine state associated with the pristine code 162. One way to support this remapping is to store the mapping to the pristine state for every instruction in the recompiled code 172. However, such a technique may incur a relatively large space overhead and may be prohibitive. Instead of such an approach, in accordance with embodiments of the invention described herein, the space overhead is limited by only storing the mapping to pristine state at the start of a compilation unit and recovering the information that is needed to map locations within the compilation unit.

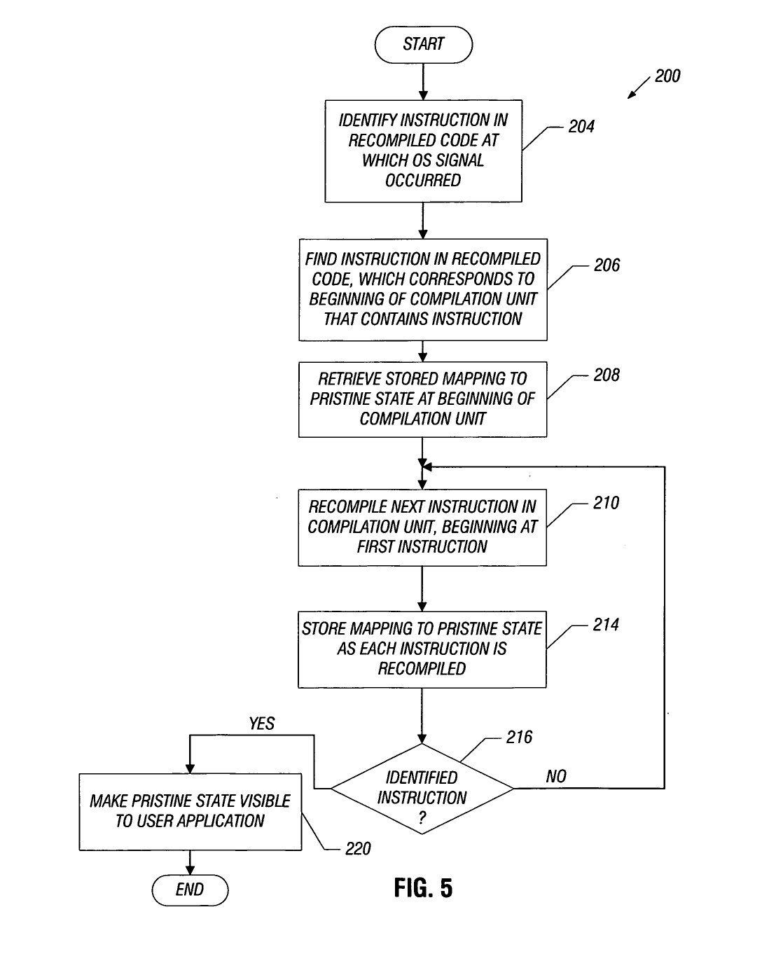

Referring to FIG. 5 in conjunction with FIGS. 1 and 3, more specifically, in accordance with some embodiments of the invention, a technique 200 may be performed by the dynamic translator 30. Pursuant to the technique 200, the dynamic translator 30 identifies (block 204) instructions in the recompiled code 172 at which the operating system signal 178 occurred. Next, pursuant to the technique 200, the dynamic translator 30 finds (block 206) an instruction in the recompiled code 172, which corresponds to the beginning of the compilation unit that contains the instruction. For example, referring also to FIG. 4, a particular instruction in the recompiled code 172 may correspond to a compilation unit 190_{P}, which has an instruction 194 that corresponds to the beginning of the compilation unit 190_{P}. The compilation unit 190_{P}, in turn, contains the compiled code that produces the instruction identified in block 204.

Next, pursuant to the technique 200, the mapping to the pristine, or ISA state, of the compiled code is retrieved at the beginning of the identified compilation unit, pursuant to block 208. Thus, referring to FIG. 4, the mapping to the pristine state that is associated with an instruction 194 at the beginning of the compilation unit 190_{P} is retrieved.

The technique 200 then begins a recompilation of the targeted compilation unit, such as the compilation unit 190_{P}, in this example. In particular, the dynamic translator 30 recompiles the next instruction in the compilation unit, beginning at the first instruction of the compilation unit, pursuant to block 210. Continuing the example, the dynamic translator 30 begins recompiling the compilation unit 190_{P}, beginning with the first instruction 194. The pristine state mapping is stored for each recompiled instruction, pursuant to block 214. Eventually, the recompiled instruction identified in block 204 is identified, pursuant to diamond 216. Upon this occurrence, the mapping to the pristine state has then been identified; and the pristine state may be made visible to the application entity 17, pursuant to block 220. Until the mapping to the pristine state has been identified, control transitions from diamond 216 back to block 210.

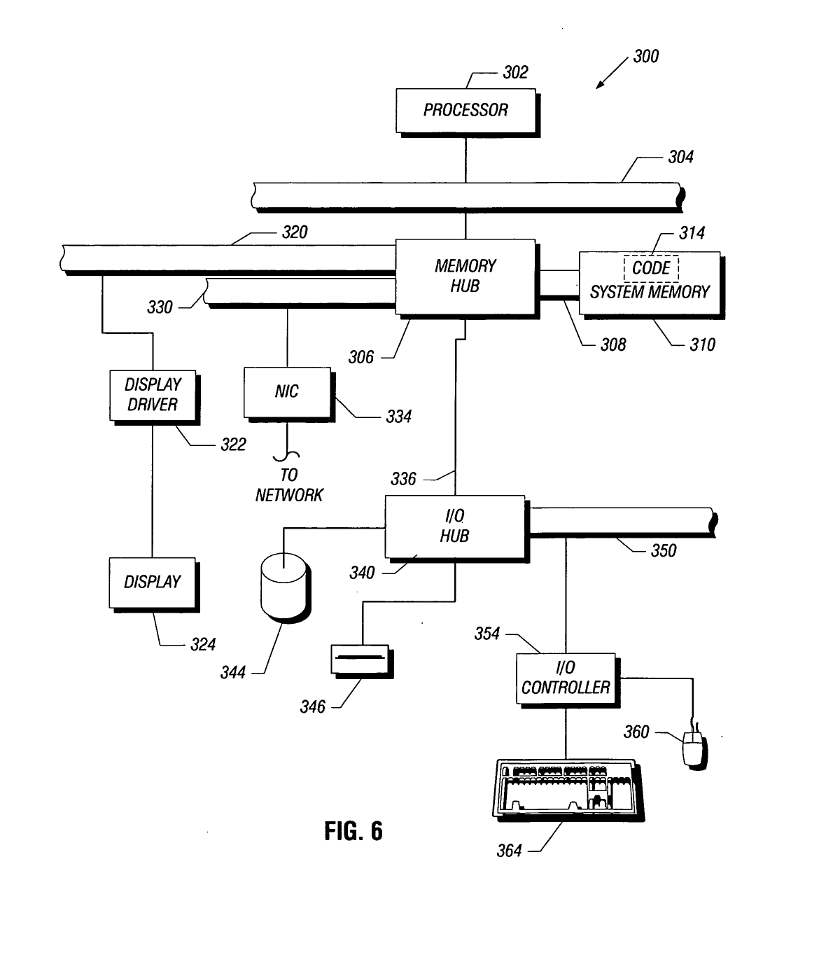

Referring to FIG. 6, in accordance with some embodiments of the invention, the software architecture that is depicted in FIG. 1 may be achieved via a computer system 300, which includes a processor 302 (one or more microprocessors or microcontrollers, as examples) that executes program code 314 that is stored in a system memory 310. Thus, the execution of the program code 314 by the processor 302 may, for example, establish the application entity 17 (managed application 15 and virtual machine 20, for example), dynamic translator 30 and operating system 50. The program code 314 also contains the byte code 162 (FIG. 3), pristine code 164 (FIG. 3) and recompiled code 172 (FIG. 3).

The computer system 300 may have a variety of different architectures, one of which is described herein for purposes of example. In this regard, the processor 302 may, along with a north bridge or memory hub 306, be coupled to a system bus 304. The memory hub 306 may, for example, provide an interface for a memory bus 308 (coupled to the system memory 310), an Accelerated Graphics Port (AGP) bus 320 and a Peripheral Component Interconnect (PCI) bus 330. The AGP standard is described in detail in the Accelerated Graphics Port Interface Specification, Revision 1.0, published on Jul. 31, 1996, by Intel Corporation of Santa Clara, Calif. The PCI Specification is available from The PCI Special Interest Group, Portland, Oreg. 97214.

A display driver 322 may be coupled to the AGP bus 320 for purposes of driving a display 324 of the computer system 300 and, as an example, a network interface card (NIC) 334 may be coupled to the PCI bus 330 for purposes of establishing communication for the computer system 300 to a network.

The memory hub 306 may be in communication with a south bridge, or input/output (I/O) hub 340, via a hub link 336. In this regard, the I/O hub 340 may provide interfaces for a hard disk drive 344 and a CD-ROM drive 346. Additionally, the I/O hub 340 may provide an interface for an I/O expansion bus 350. An I/O controller 354 may be coupled to the I/O expansion bus 350 for purposes of receiving input from a mouse 360 and a keyboard 364.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
communicating a message to a dynamic translator in response to a change which affects the validity of a translation performed by the dynamic translator.

2. The method of claim 1, further comprising:
providing code to the dynamic translator for translation, wherein
the communication occurs in response to a determination that the code has been modified after the act of providing.

3. The method of claim 1, further comprising:
providing code to the dynamic translator for translation; and
storing the code in a code cache, wherein
the communication occurs in response to overwriting at least part of the code in the code cache.

4. The method of claim 3, wherein overwriting occurs in response to eviction of code from the code cache.

5. The method of claim 3, wherein overwriting occurs in response to optimization of the code in the code cache.

6. The method of claim 1, further comprising:
providing code to the dynamic translator for translation; and
storing the code in a code cache, wherein
the communication occurs in response to redirecting execution of the code to replacement code used as a substitute for code in the code cache.

7. The method of claim 1, wherein communicating comprises transmitting the message from an application entity translated by the dynamic translator to the dynamic translator.

8. The method of claim 1, wherein communicating comprises communicating an operating system message to the dynamic translator and using the dynamic translator to recognize the operating system message as a message for the dynamic translator.

9. A method comprising:
executing recompiled code generated by a dynamic translator in response to compiled code;
in response to an operating signal occurring during execution of the recompiled code, identifying a partial segment of the compiled code; and
recompiling the partial segment to generate a mapping to a state associated with an instruction of the compiled code which caused the operating system signal.

10. The method of claim 9, wherein recompiling comprises:
recompiling each instruction of the segment of the compiled code; and
as said each instruction of the segment of the complied code is recompiled, storing a mapping associated with said each instruction.

11. The method of claim 9, further comprising:
in response to the operating system signal occurring, identifying an instruction in the recompiled code; and
based on the identified instruction in the recompiled code, identifying the partial segment of the compiled code.

12. The method of claim 11, wherein the compiled code is subdivided into compilation units, and the act of identifying the partial segment comprises identifying one of the compilation units.

13. The method of claim 9, further comprising:
indicating the state to a user application.

14. The method of claim 9, wherein the state comprises at least one of an address of the instruction and a register state.

15. A system comprising:
a dynamic translator; and
an application entity to communicate a message to the dynamic translator in response to a change which affects the validity of a translation performed by the dynamic translator.

16. The system of claim 15, wherein
the application entity provides code to the dynamic translator for translation, and
the application manager communicates the message to the dynamic translator in response to a determination that the code has been modified.

17. The system of claim 15, wherein
the application entity comprises a code cache, and
the application entity communicates the message to the dynamic translator in response to at least part of code in the code cache being overwritten.

18. The system of claim 15, wherein
the application entity comprises a code cache, and
the application entity communicates the message to the dynamic translator in response to the redirection of execution of code in the code cache to replacement code used as a substitute for the code in the code cache.

19. The system of claim 15, wherein the message comprises an intended operating system call, and the dynamic translator recognizes the message as a direct call to the dynamic translator.

20. An article comprising a computer accessible storage medium storing instructions that when executed by a computer cause the computer to:
execute recompiled code generated by a dynamic translator in response to compiled code;
in response to an operating system occurring during execution of the recompiled code, identify a partial segment of the compiled code; and
recompile the partial segment to generate a mapping to a state associated with an instruction of the compiled code which cause the operating system signal.

21. The article of claim 20, the storage medium storing instructions that when executed by the computer cause the computer to:
recompile each instruction of the segment of the compiled code; and
as said each instruction of the segment of the compiled code is being recompiled, store a state associated with said each instruction.

22. The article of claim 20, the storage medium storing instructions that when executed by the computer cause the computer to:
in response to the operating system signal occurring, identify an instruction in the recompiled code; and
based on the identified instruction in the recompiled code, identify the partial segment of the compiled code.

23. The article of claim 22, wherein the compiled code is subdivided into compilation units and the storage medium stores instructions that when executed by the computer cause the computer to identify one of the compilation units.

24. The article of claim 20, the storage medium storing instructions that when executed by the computer cause the computer to identify the state to a user application.

25. The article of claim 20, where the state comprises at least one of an address of the instruction and a register state.
